(19) United States
(12) Patent Application Publication
(10) Pub. No.: US 2008/0162432 A1
(43) Pub. Date: Jul. 3, 2008

(54) Search table for unary k-th order exp-golomb decoder

(76) Inventor: Wen-Shan Wang, Chandler, AZ (US)

Correspondence Address: BUCKLEY, MASCHOFF & TALWALKAR LLC, 50 LOCUST AVENUE, NEW CANAAN, CT, 06840, US

(21) Appl. No.: 11/648,118

(22) Filed: Dec. 29, 2006

(51) Int. Cl. G06F 17/30

(52) U.S. Cl. 707/3

(57) ABSTRACT

According to some embodiments, bin data may be input and, based on a portion of the bin data, an entry in a search table may be determined. An indication of whether the search is complete may then be read from the search table along with at least one of: (i) a base symbol value or (ii) information about a next node. If the search is not complete, the process may continue to determine entries in the search table based on the information about the next node and additional portions of the bin data. When the search is complete, a decoded symbol may be calculated based on the last base symbol value and a remaining portion of the bin data associated with an extra bin length read from the search table.

### BACKGROUND

In some cases, an algorithm may be used to reduce an amount of data that is transmitted between devices. Consider, for example, a media player that outputs moving images to a display device. The media player might retrieve locally stored image information or receive a stream of image information from a media server (e.g., a content provider might transmit a stream that includes information about high-definition image frames to a television, a set-top box, or a digital video recorder through a cable or satellite network). Such image information may be encoded to reduce the amount of data used to represent the image. For example, an image might be divided into smaller image portions, such as macroblocks, so that information encoded with respect to one image portion does not need to be repeated with respect to another image portion (e.g., because neighboring image portions may frequently have similar color and brightness characteristics). Moreover, algorithms, such as Varied Length Coding (VLC) or Context-Based Adaptive Binary Arithmetic Coding (CABAC) may be used to reduce the number of bits that are needed to represent the image. Thus, improving the efficiency of such algorithm implementations may improve the performance and/or reduce the cost of such devices.

### BRIEF DESCRIPTION OF THE DRAWINGS

FIG. 1 is a block diagram of a media system.

FIG. 2 is a flow diagram illustrating a decoding method.

FIG. 3 illustrates an encode table and an associated serial search tree.

FIG. 4 is a serial search table associated with the encode table and serial search tree of FIG. 3.

FIG. 5 is table illustrating binarizations for UEG3 with uCoff=9.

FIG. 6 is a UEGk search tree associated with the binarizations of FIG. 5 according to some embodiments.

FIG. 7 is a UEGk search table associated with the search tree of FIG. 6 according to some embodiments.

FIG. 8 is a flow diagram illustrating a method according to some embodiments.

FIG. 9 is a block diagram of a system according to some embodiments.

### DETAILED DESCRIPTION

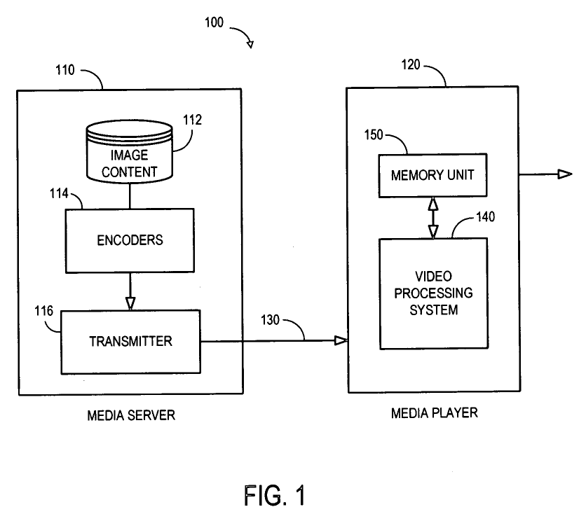

Although some embodiments will be described with respect to media devices, note that embodiments may be associated with any systems or devices that may benefit from the techniques described herein. Consider, for example, a media player that receives image information, decodes the information, and outputs a signal to a display device. Such a media player might be a Digital Video Recorder (DVR) that retrieves locally stored image information, or a set-top box that receives a stream of image information from a remote device (e.g., a content provider might transmit a stream that includes information about high-definition image frames to the set-top box through a cable or satellite network). FIG. 1 is a block diagram of a media system 100 including a media server 110 that provides image information to a remote media player 120 through a communication network 130.

According to some embodiments, the encoders 114 and/or video processing system 140 (e.g., along with a memory unit 150) of the media player 120 may use algorithms to reduce the amount of information that needs to be transmitted in order to represent an image. That is, the encoders 114 may reduce the amount of data that is required to represent image content 112 before the data is transmitted by a transmitter 116 as a stream of image information. As used herein, information may be encoded and/or decoded in accordance with any of a number of different protocols. For example, image information may be processed in connection with International Telecommunication Union-Telecommunications Standardization Sector (ITU-T) recommendation H.264 entitled “Advanced Video Coding for Generic Audiovisual Services” (2004) or the International Organization for Standardization (ISO)/International Engineering Consortium (IEC) Motion Picture Experts Group (MPEG) standard entitled “Advanced Video Coding (Part 10)” (2004).

Unlike typical a VLC algorithm, which decodes a symbol directly from a bit stream, the CABAC approach decodes the symbol from a bin string (e.g., bit) which is computed bin-by-bin from the bit stream. In order to speed up the process, a VLC decoder may read more bits than what the symbol being decoded needs (and keep the unused bits in an internal buffer for later use). A CABAC decoder, however, shouldn't read too many bins because it will waste time on the unnecessary computation and may degrade the context variables required by the bin computation if too many bins are derived.

In addition to being a relatively slow process, bin-by-bin decoding may result in poor resource sharing because different binarizations, which contain many bin strings and their corresponding Syntax Element symbols (SE) and are similar to VLC lookup tables, may need different decoding flows. In H.264, for example, 24 syntax elements may use CABAC and more than 15 binarizations may be needed. According to H.264 C reference code, moreover, many CABAC binarizations have individual decoding parsers. As a result, implementations may be complex and costly.

Note that seven of the 24 syntax elements coded with CABAC use Unary (U), Truncated Unary (TU), and Unary k-th Order Exp-Golomb (UEGk) algorithms to create binarizations. Some embodiments described herein may provide an efficient methodology to unify the decode process for these algorithms so that a single bin string decoder, instead of seven bin string decoders, may be used. Such an approach may, for example, substantially reduce the gate count of the implementation.

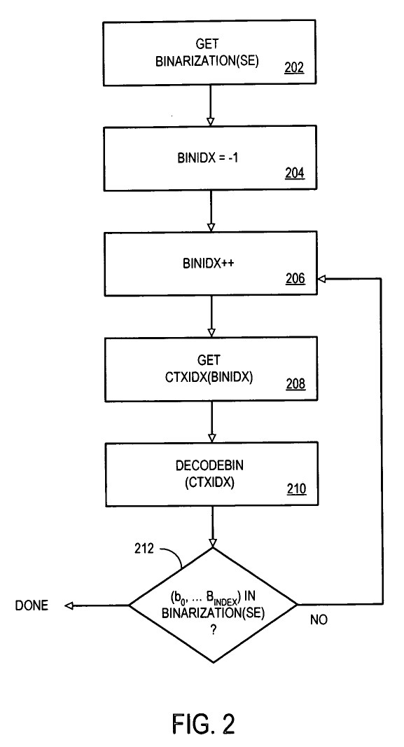

FIG. 2 is a flow diagram illustrating an H.264 decoder CABAC parsing process for a Syntax Element (SE). A 202, the binarization for a specific SE is generated or obtained, and a bin string is null at 204 and 206. Note that the binarization may be similar to a VLC table. With binarization, the encoder may uses it as a lookup table to map the SE symbol (or symbol) to a bin string and the decoder uses it to find the SE symbol by tracing each coming bin data. In the parsing loop, the context index (ctxIdx) is derived from bin index (binIdx) at 208, one bin of the bin string is computed from ctxIdx, and a new bin string is created by concatenating the previous bin string with this new bin at 210. At 212, the new bin string is compared with all bin strings in binarization. If the new bin string matches with any in the binarization at 212, the process is done and a SE symbol is output. Otherwise, the next parsing iteration starts at 206.

Note that the H.264 standard doesn't define how the computed new bin string (b₀, . . . , b_{bindix}) should be compared with the bin strings in the binarization. If the system compares one bin string in binarization after another, the implementation may be inefficient. For example, the process might compare the bin string N times if there are N symbols in the binarization and an SE is not found. Similarly, the process would compare up to N*6 times if a symbol were found in the 6th iteration. Assuming a maximum bin length of M, then N*M comparisons may be required. Consider, for example, a binarization with 26 SE symbols (N=26) and the maximum bin length is 7 (M=7), then the worst case would be 26*7=182 comparisons to decode a symbol. Such an approach may be a time consuming process.

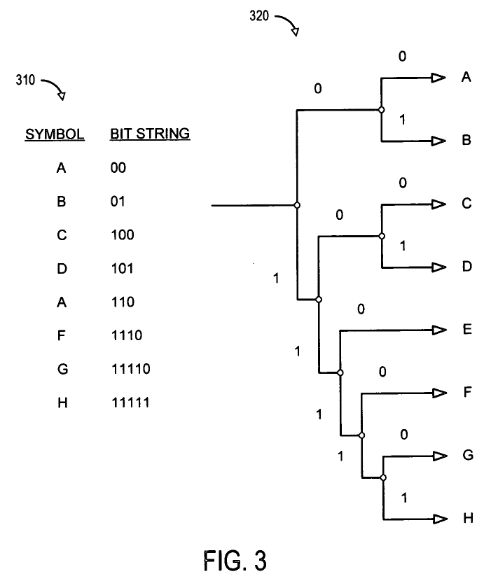

Also note that a CABAC bin string may be prone to decoded in a bin-by-bin manner because the bin values are computed one-by-one. Therefore, a “serial search approach” may be appropriate for CABAC bin string decoding. The serial search approach may process an input bit-stream serially, one bit at a time, and utilize a constructed “serial search tree.” FIG. 3 illustrates an encode table 310 that maps symbols to bit strings and an associated serial search tree 320. Starting from the root of the tree 320, the approach traverses, depending on the bit value, the branches of the tree 320 until it a terminal leaf is reached. At the terminal leaf, the code word is fully decoded, and the corresponding symbol can be output. The process then repeats, starting at the root of the tree 320, for the next symbol. In the worst case, the approach needs to search M times in order to get a symbol, where M is the longest bit length.

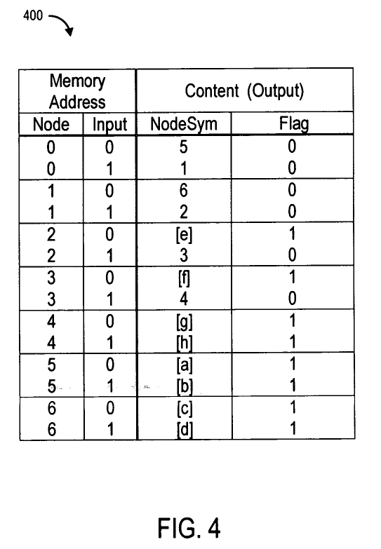

In some cases, the serial search tree is converted using a serial search table stored in a buffer for a software or hardware implementation. FIG. 4, for example, is a serial search table 400 associated with the encode table 310 and serial search tree 320 of FIG. 3. Note that mapping the decoding tree 320 to the search table 400 to be stored in a buffer might not be a straightforward task. Referring to the search table 400, the “input” is the bit, or bin and the “node” represents an intermediate point before a symbol is determined. The buffer memory address is composite of the node and input values. There are two fields in the buffer data “NodeSym” and “flag.” NodeSym contains either the next node number or the symbol (represented with [x] in the search table). The flag value indicates whether the symbol is found. If flag the flag value is one, the NodeSym is a symbol and the search is complete. If the flag value is zero, NodeSym represents the appropriate node for the next move.

When search starts, the node value is zero, representing the root of serial search tree. After getting an input bit, or bin, the combination of node and input is the address of the search table 400 in the buffer and the NodeSym and flag are read out.

Here is an example of decoding the string “101” (referring to the search table 400 of FIG. 4):

Starting with node=0 and input=1, it can be seen that NodeSym=1 and flag=0. As a result, address 1 will be the next node.

Now looking at node=1 and input=0, it can be seen that NodeSym=6 and flag=0. As a result, address 6 will be the next node.

Now using node=6 and input=1, it can be seen that NodeSym=d and flag=1. Thus, “d” is the symbol and decoding is complete.

Comparing the search tree 320 of FIG. 3 and the search table 400 of FIG. 4, it can be seen that each represent the same tree expressed in different ways. Each node has two branches: one represents 1 and the other with 0. When each reaches the end, a symbol is there. When an intermediate node is reached, the next node can be determined using the next input bit.

Such a serial search approach may, however, have several disadvantages. For example, the size of the data table required may be substantial (e.g., to contain all necessary symbols and search nodes). Usually, the number of entries in the serial search table 400 is between double and triple the number of potential symbols, depending to the encode table. The more symbols, the bigger buffer size is required to store the search table 400.

As a result, it can be difficult to use a serial search scheme for UEGk binarization because the number of symbols of the coefficient level of H.264 is 256, and UEGk can generate a binarization for an unlimited number of symbols. We do need a smaller size of buffer for the hardware implementation.

The UEGk algorithm used in H.264 CABAC coding is for the syntax elements of motion vectors, UEG3 with uCoff=3, and coefficient absolute levels, UEG0 with uCoff=14. The UEGk algorithm is the superset of TU and Exp-Golomb algorithms, which are often used in H.264 video coding, because the UEGk combines the TU and Exp-Golomb, the former is the prefix part while the latter is suffix part of UEGk.

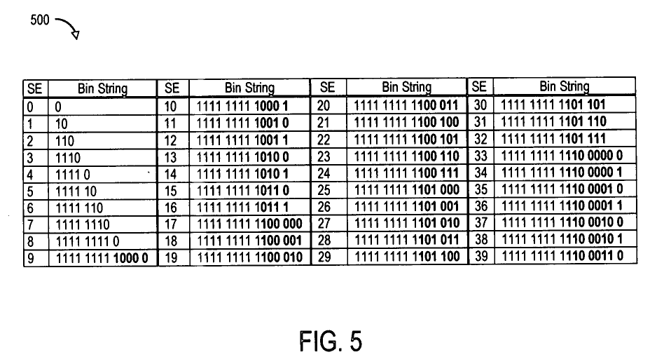

Consider, for example, FIG. 5 which is table 500 illustrating binarizations for UEG3 with uCoff=9. The UEGk is a function of “uCoff” and “k.” The uCoff value represents the length of TU while the k value indicates the order of Exp-Golomb. The table 500 includes the first 40 symbols of the binarization for UEG3 with uCoff=9. Note that a sign bit may follow the UEGk bin string (but is not illustrated in FIG. 5 for clarity).

In the table 500, the first 9 SE symbols (SE 0 through 8), use TU with uCoff=9 to encode or decode while the rest of the SE symbol's use the 3th order Exp-Golomb. In other words, the first 9 SE symbols only have prefix bins while the rest have 9 1's as the prefix bin and several suffix bins coded by EG3 algorithm. (the suffix bins are illustrated in bold in FIG. 5).

The following pseudo code, adapted from ITU-T Recommendation H.264, illustrates how to generate the suffix of UEGk binarization. Where, the sufS=symbol value−uCoff. This pseudo code illustrates that the suffix bins starts from a number of leading 1's, followed by a leading 0, followed by a number of extra bins. Assume the number of leading 1's is N₁ and the number of extra bins is N_{E}, then N_{E}=k+N₁.

| | | |
|---|---|---|
| StopLoop = 0 | | |
| do { | | |
| if(sufS >= (1 << k)) { | | // check if symbol >= (1 << |
| k), if so... | | |
| put(1) | // | putting a leading 1 |
| sufS = sufS − (1<<k) | // | get new symbol value |
| k++ | // | increase k by 1 and check |
| again | | |
| } else { | | // until symbol < (1 << k) |
| put(0) | // | put a leading 0 |
| while(k−−) | // | then put k number of extra |
| bin(s) | | |

```
        put((sufS >> k) & 0 × 01)
    stopLoop = 1
}
} while(!stopLoop)
```

For instance, for symbols SE 9 through 16 in the table 500, the N₁=0 and N_{E}=k+0=3; there is no leading 1 but a leading 0. The extra bins starts from 000 to 111. For symbols SE 17 through 32 in the table 500, N₁=1 and N_{E}=k+1=4. The leading bits are 10, one leading 1 and one leading 0, and the extra bins are from 0000 to 1111. For symbols SE 33 through 64, the leading bits are 110, 2 leading 1's and 1 leading 0, and the extra bins are from 00000 to 11111.

Note that the binarization generated by UEGk with uCoff algorithm may have the following characteristics:

1) For the symbols between 0 and (uCoff−1), the bin strings may have only a prefix part, which includes a number of leading 1's followed by a 0. The number of leading 1's may be equal to the symbol value.

2) For the symbols greater than or equal to uCoff, the bin strings may consist of a prefix and a suffix part:
a) The prefix may be uCoff number of 1's.
b) The suffix may be coded with kth order Exp-Golomb.

In additions, the following features of the suffix of the bin string or the kth order Exp-Golomb code may be noted:

1) Extra bins with a given length may be lexicographically consecutive with increment 1.

2) Symbols for the bin strings with a given extra bin length may also be consecutive with increment 1.

3) The extra bins, which are following to the leading 0, may have all values from all 0's to all 1's.

For example, the extra bin length for the SE symbols 9 through 16 is 3 and their extra bin values are from 000 to 111; the extra bin length for SE symbols 17 through 32 is 4 and their extra bin values are from 0000 to 1111.

With the mentioned features of the UEGk, some embodiments may implement a serial search scheme that may require a substantially smaller buffer for decoding. For example, there may be a very close relationship between the extra bin values and the symbol values. For a given bin length, if the symbol for the smallest extra bin value for a given length is know, then all other symbol values with the same extra bin length may be determined. Moreover, extra bins may cover all possible values for a given extra length. As a result, all possible strings with the same bin length might share a single leaf of a search tree.

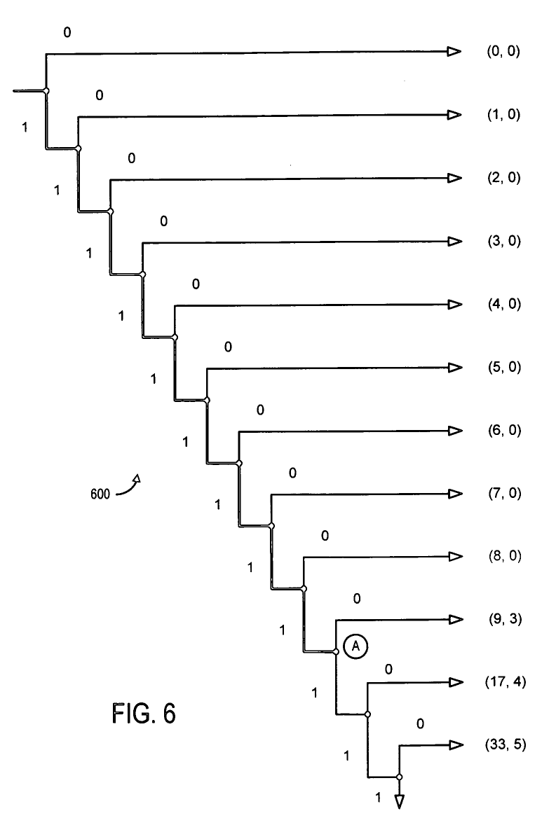

According to some embodiments, a UEGk search tree can be constructed without having leaves for every SE symbol in the binarization. That is, the tree might use a small number of leaves for the base symbols. for example, FIG. 6 is a UEGk search tree 600 associated with the binarizations of FIG. 5 according to some embodiments (is a UEGk search tree for UEGk with uCoff=9). The number at the leaf is not the symbol but instead indicates the base symbol along with the extra bin length (represented as “(base symbol, extra bin length)” in FIG. 6). If the extra bin length is 0, the SE symbol is same as the base symbol and bin string decoding completes the process. If the extra bin length is not 0, the process needs to get a number of extra bins according to the extra bin length, convert the bins to decimal values, and then add to the base symbol to obtain the SE symbol. If the extra bin length is m, for example, then the decoder needs to get an extra m bins.

Using the bin string “1111 1111 1010 1” as an example. the 1st 9 1's drive the traverse to arrive at node “A” in FIG. 6, and the next 0 makes it reach leaf (9, 3). The base symbol value is 9, the extra 3 bins are interpreted as 5, and the final SE symbol is 9+5=14.

According to some embodiments, an appropriate UEGk search table is built and saved in the buffer of a UEGk binarization decoder. The following pseudo code describes one method of building such a UEGk search table referred to as UEGkTree[ ]. Each element of the UEGkTree[ ] contains three members, NodeSym, Ext, and Flag:

| | |
|---|---|
| Let all SerialSearch[ ].NodeSym = −1. | // The NodeSym = −1 |
| Let NewNode = 1. | // represents unused node |

```
For every bin string in a binarization {
    Get one bin string.
    Let Node = 0.
    For every Bin[n] in the bin string, where n = 0, 1, ...(maximum bin
    length − 1) {
        Addr = Node << 1.
        If (Bin[n] value is 1) {
            Addr = Addr + 1.
            If (UEGkTree[Addr].NodeSym = −1) {
                Let UEGkTree[Addr].NodeSym = Node =
                NewNode.
                Set UEGkTree[Addr].Flag = 0;
                NewNode = NewNode + 1.
            } else
                Node = UEGkTree[Addr].NodeSym
```

| | |
|---|---|
| } else { | // If Bin[n] value is 0, |

```
            Set UEGkTree[Addr].Flag = 1;
            If (n < uCoff) {
                UEGkTree[Addr].Ext = 0;
                UEGkTree[Addr].NodeSym = n;
            }else {
                UEGkTree[Addr].Ext = E = n − uCoff;
                UEGkTree[Addr].NodeSym = uCoff + 2(k +
                E) − 2k;
            }
            Break the inner for-loop;
        }
        n = n + 1.
    }
}
```

Note that according to the pseudo code:

1) Each bin of each bin string in a UEGk binarization travels the search tree (still being constructed) from the root to one leaf.

2) If the bin value is 1, the process has reached a node. If it is an used node, it takes that node number; otherwise, a new node number is assigned to the node. The node number may be combined with coming bin value for the next move.

3) If the bin value is 0, it has reached a leaf. If it is a prefix bin, and there are no more extra bins, then the symbol is equal to the bin number; otherwise, the extra bin length and the base symbol value are evaluated.

4) When all bins of all bin strings complete the traveling, the appropriate node numbers, base symbols, extra bin lengths and flags are then assigned to all nodes and leafs.

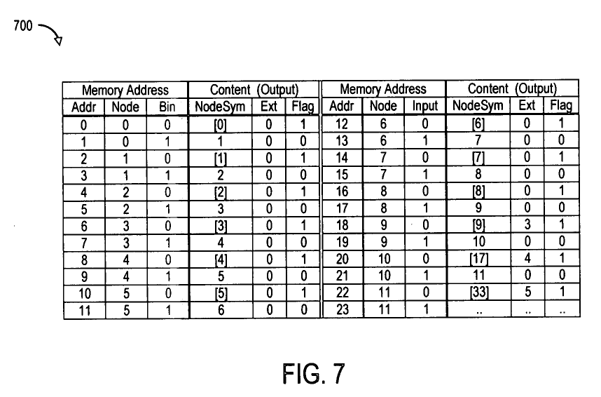

FIG. 7 is a UEGk search table 700 associated with the search tree 600 of FIG. 6 according to some embodiments. In particular, FIG. 7 illustrates the first 24 entries of the UEGk search table 700 for the binarization of UEG3 with uCoff=9. To decode 64 symbols, the UEGk search scheme might only require 24 entries as compared to a conventional serial search scheme which might need about 128 or more entries. Note that, in the NodeSym columns in the search table 700, the numbers in [ ] represent the base symbols; otherwise, the numbers are Node numbers.

The UEGk search table 700 might be built off-line and stored to a local buffer of a CABAC decoder before starting the process. In such cases, building the table might not affect the performance of the decoder.

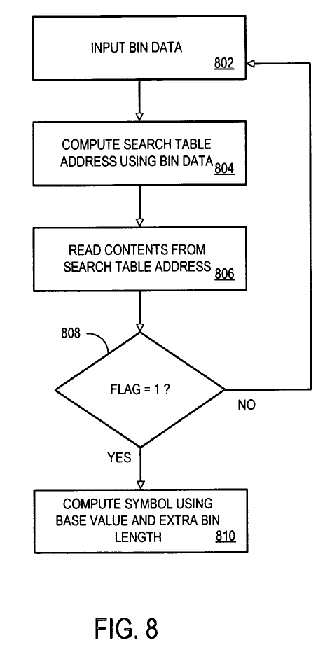

According to some embodiments, decoding the bin string may be substantially simpler than building the UEGk search table 700. FIG. 8 is a flow diagram illustrating a method of decoding the bin string according to some embodiments. The method may be performed, for example, by the video processing system 140 of FIG. 1. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 802, a decoder may input bin data. The bin data may then be used at 804 to compute a search table address. At 806, the search table address is used to read the contents (Flag, Ext, and NodeSym) from the search table buffer. If the value of Flag is not “1” at 808, the process continues to input bin data at 802. If the value of Flag is “1” at 808, the decoder may input a number of extra bins, according to the Ext value, and compute the symbol value at 810. For example, the following pseudo code may demonstrated the binarization decoder according to some embodiments:

```
Let n = Node = Flag = 0;
While(Flag == 0) {
    Input one Bin.
    Read NodeSym, Ext, and Flag from address of (Node * 2 + Bin)
    If Flag = 0, Node = NodeSym.
}
While(Ext) {
    Let n = n * 2;
    Input one Bin
    Let n = n + Bin.
}
Symbol = NodeSym + n
```

Using bin string “1111 1111 1010 1” again as example, the above pseudo code and the UEGk search table 700 of FIG. 7 may demonstrate how to derive the appropriate symbol value:

1) The address after inputting the 1st ‘1’ is 1 (0+1=1) and it contains Flag=0 and Node=1.

2) The address after inputting the 2nd ‘1’ is 3 (1*2+1=3) and it contains Flag=0 and Node=2. The process continues similarly unit the address after inputting the 9th ‘1’ is 19 (8*2+1=17) and it contains Flag 0 and Node=9.

3) Finally, the 1st ‘0’ is input and the address becomes 18 (9*2+0=18) and it gets Flag=1, NodeSym=9, and Ext=3.

4) The 1st extra bin is 1 and n=0*2+1=1.

5) The 2nd extra bin is 0 and n=1*2+0=2.

6) The last extra bin is 1 and n=2*2+1=5. Therefore, the Symbol=9+5=14.

Thus, some embodiments of the UEGk bin string decoder described herein may provide a substantially smaller table size. For example, the required buffer size may be one fifth as compared to a conventional serial search scheme for the 1 st 64 symbols of the UEG9 binarization with uCoff=9. In case of search first 128 symbols of the same binarization, some embodiments may use a table with only 26 entries while a conventional serial search scheme might require a table with about 256 entries. Note that such improvements may increase as the binarization size increases.

Also note that some embodiments of the UEGk bin string decoder described herein may support other types of binarizations. For example, according to the H.264 Specifications, seven of the 24 syntax elements that are coded by CABAC use U, TU, and UEGk algorithms to create the binarizations. All of those binarizations might share the same hardware architecture (because the U and TU are subsets of UEGk).

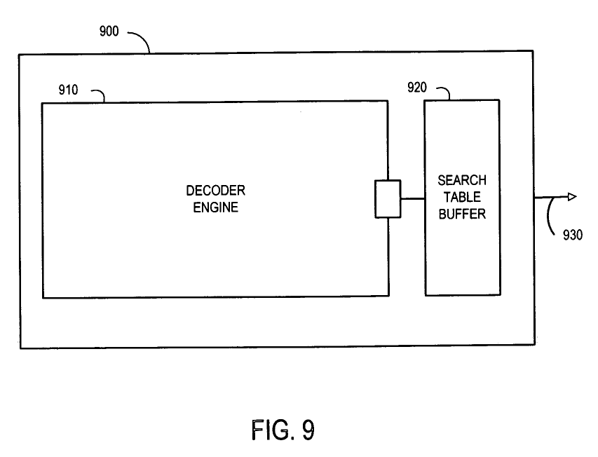

FIG. 9 is a block diagram of a system 900 according to some embodiments. The system 900 may be associated with, for example, a digital display device, a television, a digital video recorder, a game device, a Personal Computer (PC), a wireless device, and/or a set-top box. The system 900 may include, for example, a decoder engine 910 and a search table buffer according to any of the embodiments described herein. According to some embodiments, the system 900 outputs a digital display signal via a digital display output port 930.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although embodiments have been described herein with respect to a particular video encoding protocol, note embodiments could be associated with other video encoding protocol and/or non-video encoding protocols. Moreover, although particular tables, values, and pseudo code have been used as examples, other approaches could be used instead to implement any of the embodiments described herein.

The several embodiments described herein are solely for the purpose of illustration. Persons skilled in the art will recognize from this description other embodiments may be practiced with modifications and alterations limited only by the claims.

What is claimed is:

1. A method, comprising:
inputting bin data;
based on a portion of the bin data, determining an entry in a search table;
reading from determined entry of the search table an indication of whether the search is complete along with at least one of: (i) a base symbol value or (ii) information about a next node;
if the search is not complete, continuing to determine entries in the search table based on the information about the next node and additional portions of the bin data; and
if the search is complete, calculating a decoded symbol based on the last base symbol value and a remaining portion of the bin data associated with an extra bin length read from the search table.

2. The method of claim 1, wherein the input bin data is associated with H.264 information.

3. The method of claim 1, wherein the search table is associated with a unary k-th order exp-Golomb algorithm.

4. The method of claim 4, wherein the search table may also be associated with a unary algorithm or a truncated unary algorithm.

5. The method of claim 1, further comprising:
outputting the decoded symbol.

6. The method of claim 1, wherein said calculating is associated with adding the base symbol read from the search table to the value of the last m bits of the input bin data, where m is the extra bin length read from the search table.

7. The method of claim 1, wherein the search table does not include a separate entry for each potential symbol to be decoded.

8. The method of claim 1, wherein the search table associated with a context-based adaptive binary arithmetic coding decoder.

9. The method of claim 1, wherein the search tables include, for each entry:
the indication of whether the search is complete;
an extra bin length; and
a value representing either (i) a base symbol value or (ii) information about a next node.

10. A method, comprising:
determining a set of unary k-th order exp-Golomb algorithm binarizations;
constructing a search table based on the set of binarizations, the search table including at least one column that may represent either (i) a base symbol value associated with a plurality of potential symbols or (ii) a next node to be used in a serial search process; and
decoding a stream of input data using the search table.

11. The method of claim 10, wherein said constructing includes, for each bin of each bin string in the binarization:
traveling the search tree, as it is being constructed, from a root to a next position;
if the bin value is one, determining that a node has been reached, and (i) if the node is unused, assigning that node number for the table or (ii) if the node is used, assigning a new node number for the node in the table, wherein the node number is to be combined with a subsequent bin value for a next move;
if the bin value is zero, determining that a leaf has been reached, and assigning a appropriate base symbol value and extra bin length for the table.

12. An apparatus, comprising:
a buffer to store a search table associated with a unary k-th order exp-Golomb algorithm; and
a decoder engine to decode input bin data based at least in part on a base symbol value and an extra bin value read from the buffer.

13. The apparatus of claim 12, wherein the decoder engine may perform decoding associated with a unary algorithm and a truncated unary algorithm.

14. The apparatus of claim 12, wherein the search table includes, for each entry:
the indication of whether the search is complete;
an extra bin length; and
a value representing either (i) a base symbol value or (ii) information about a next node.

15. The apparatus of claim 12, further comprising:
an input port to receive the input bin data, wherein the input bin data is associated with H.264 information.

16. An apparatus comprising:
a computer-readable storage medium having stored thereon instructions that when executed by a machine result in the following:
inputting bin data,
based on a portion of the bin data, determining an entry in a search table;
reading from determined entry of the search table an indication of whether the search is complete along with at least one of: (i) a base symbol value or (ii) information about a next node,
if the search is not complete, continuing to determine entries in the search table based on the information about the next node and additional portions of the bin data, and
if the search is complete, calculating a decoded symbol based on the last base symbol value and a remaining portion of the bin data associated with an extra bin length read from the search table.

17. The apparatus of claim 16, wherein said calculating is associated with adding the base symbol read from the search table to the value of the last m bits of the input bin data, where m is the extra bin length read from the search table.

18. The apparatus of claim 17, wherein the search tables include, for each entry:
the indication of whether the search is complete;
an extra bin length; and
a value representing either (i) a base symbol value or (ii) information about a next node.

19. A system, comprising:
a buffer to store a search table associated with a unary k-th order exp-Golomb algorithm;
a decoder engine to decode input bin data based at least in part on a base symbol value and an extra bin value read from the buffer; and
a digital output to provide a digital signal to a digital display device.

20. The system of claim 19, wherein the system is associated with at least one of:
(i) a digital display device, (ii) a television, (iii) a digital video recorder, (iv) a game device, (v) a personal computer, (vi) a wireless device, or (vii) a set-top box.
